(19) United States
(12) Patent Application Publication
(10) Pub. No.: US 2026/0342200 A1
(43) Pub. Date: Oct. 29, 2026

(54) CASCADED AUXILIARY VOLTAGE SUPPLY DEVICE FOR SUPPLYING VOLTAGE TO CONTROL ELECTRONICS OF A MODULE OF A MULTILEVEL CONVERTER

(71) Applicant: Siemens Energy Global GmbH & Co. KG.,, Muenchen (DE)

(72) Inventors: Sebastian Kröppel, Hirschaid (DE); Peter Maisel, Nürnberg (DE); Daniel Böhme, Nürnberg (DE)

(21) Appl. No.: 19/662,002

(22) Filed: Apr. 29, 2026

(30) Foreign Application Priority Data
Apr. 29, 2025 (DE) 102025116390.1

(51) Int. Cl. H02M 1/00; H02M 1/44

(52) U.S. Cl. CPC H02M 1/0006; H02M 1/0054; H02M 1/44

(57) ABSTRACT

An auxiliary voltage supply device supplies a voltage to control electronics of a module of a multilevel converter. An intermediate circuit capacitor of the module is provided as a voltage source for the auxiliary voltage supply device. The auxiliary voltage supply device has an input that can be connected to the intermediate circuit capacitor and an output. The auxiliary voltage supplied by the auxiliary voltage supply device can be tapped between an output and a ground connection of the auxiliary voltage supply device. A cascade of linear regulator stages is connected between an input and an output. Wherein each linear regulator stage has a normally on MOSFET and at least one reference diode which is connected to the gate electrode of the MOSFET, and wherein the MOSFETs of all linear regulator stages are connected to one another in series.

### CROSS-REFERENCE TO RELATED APPLICATION

This application claims the priority, under 35 U.S.C. § 119, of German Patent Application DE 10 2025 116 390.1, filed Apr. 29, 2025; the prior application is herewith incorporated by reference in its entirety.

### FIELD AND BACKGROUND OF THE INVENTION

The invention relates to an auxiliary voltage supply device for supplying voltage to control electronics of a module of a multilevel converter. An intermediate circuit capacitor of the module is provided as voltage source for the auxiliary voltage supply device. The auxiliary voltage supply device has an output and an input that can be connected to the intermediate circuit capacitor, and the auxiliary voltage supplied by the auxiliary voltage supply device can be tapped between the output and a ground connection of the auxiliary voltage supply device.

It is known to supply the control electronics (auxiliary voltage supply) of a multilevel converter from the intermediate circuit capacitor (submodule capacitor) of the power circuit.

The voltage of this capacitor is not constant and varies in the range from e.g. 0 - 6500 V. This poses particular obstacles to implementation for realizing the auxiliary voltage supply. Owing to the required low start-up voltage (e.g. < 500 V), a wide-band operating range results, which cannot be realized using conventional topologies.

For symmetrization purposes of the multilevel converter, a sufficiently pronounced resistive character of the auxiliary voltage supply is necessary. Pure switched-mode power supply topologies (negative internal resistance, power sink) are therefore only suitable for use to a limited extent.

The implementation of a voltage supply with resistive character is frequently associated with the use of a switched voltage divider (single- or multi-phase). Due to the requirement for a wide input voltage range, voltage dividers that can be switched in a multi-stage manner are for the most part used. This concept is based on active regulation, which must be configured depending on the applied submodule capacitor voltage and the energy requirement of the assembly.

For example, using a switchable series resistor (actively cooled power resistor), it is possible to divide the module voltage to a voltage level for conventional switched-mode power supply topologies (e.g. flyback converter) and provide it to an intermediate circuit capacitor. On the basis of this reduced intermediate circuit voltage, the desired small voltage (e.g. 15 V - 24 V) for direct supply of the assemblies can be generated using a DC/DC converter.

### SUMMARY OF THE INVENTION

The known solutions are technically complex and are poorly scalable. The object of the invention is therefore to provide an auxiliary voltage supply device which has a simple and easily scalable structure.

The object is achieved by an auxiliary voltage supply device as claimed in the independent auxiliary voltage supply device claim. Advantageous embodiments are the subject matter of the dependent claims.

The invention provides a cascaded auxiliary voltage supply device for supplying voltage to control electronics of a module of a multilevel converter, which is distinguished by the fact that a cascade of linear regulator stages is connected between the input and the output. Each linear regulator stage has a normally on MOSFET (metal oxide semiconductor field effect transistor) and at least one reference diode which is connected to the gate electrode of the MOSFET, and wherein the MOSFETs of all linear regulator stages are connected to one another in series.

This solution makes an inherent regulation behavior possible, that is to say a dynamic continuously variable voltage regulation and therefore makes it possible to dispense with active regulation. A reduced number of components compared to previous solutions leads to a better FIT rate (FIT: failure in time) and can offer cost advantages.

By means of the series connection of further linear regulator stages, it is possible to adapt the solution to various voltage levels as desired. As a result, the solution according to the invention can be scaled easily.

In contrast to previous solutions, also no hard switching of the power components at high voltage potential takes place. As a result, it is possible to dispense with high-resistance or galvanically isolated control electronics.

In addition, the risk of EMC interferences is reduced (EMC: electromagnetic compatibility). Furthermore, the cascaded auxiliary voltage supply device has a linear purely resistive internal resistance across a defined operating range.

The linear internal resistance promises advantages in the regulation algorithms of a multilevel converter, because a more precise symmetrization of the submodule capacitors is possible as a result across the entire defined operating range.

Due to the characteristic of the internal resistance, the power loss of the auxiliary voltage supply device is linear and the power loss is lower compared to the previous solution.

A lower power loss means an improved loss evaluation of the multilevel converter and saves costs as a result. With increasing operating voltage, the efficiency advantage even increases compared to the previous solution.

The normally on MOSFETs are conductive in a de-energized state and transition to a partially conductive state in the case of a sufficiently negative gate-source voltage. The modules of the multilevel converter are also referred to as submodules or power modules.

The solution according to the invention may be improved further by different embodiments that are each advantageous on their own and may be combined with one another as desired. These embodiments and the advantages associated therewith will be discussed below.

Preferably, the reference diodes are Zener diodes, the breakdown voltages of which define the setpoint voltages of the respective linear regulator stages. The breakdown voltage of the at least one reference diode can control the gate-source voltage of the associated MOSFET.

The output voltage of a linear regulator stage is used preferably as a reference for the subsequent linear regulator stage.

Particularly preferably, the MOSFET of the first linear regulator stage is connected at its source electrode to the output of the auxiliary voltage supply device. In this case, preferably exactly one reference diode is connected between the gate electrode of the MOSFET and the ground connection of the auxiliary voltage supply device. Alternatively, instead of the exactly one diode, a diode arrangement can be provided, which is composed of a series connection of a plurality of diodes.

The linear regulator stages are preferably arranged in the following order: The first linear regulator stage (linear regulator stage 1) is, as described above, connected via the source electrode of its MOSFET to the output of the auxiliary voltage supply device. From there, the number of linear regulator stages increases in the direction of the input.

According to an advantageous embodiment of the auxiliary voltage supply device, at each linear regulator stage greater than 1, the respective MOSFET can be connected via its source electrode to the drain electrode of the MOSFET of the next lowest linear regulator stage. The output voltage of the linear regulator stage of the next lowest linear regulator stage is in this case used as a reference for the first mentioned linear regulator stage.

Preferably, at each linear regulator stage greater than 1, exactly one reference diode is connected between the gate electrode of the MOSFET of this linear regulator stage and the source electrode of the MOSFET of the next lowest linear regulator stage.

According to an alternative configuration, at each linear regulator stage greater than 1, a plurality of reference diodes is connected in a series connection between the gate electrode of the MOSFET of this linear regulator stage and the ground connection of the auxiliary voltage supply device. The number of reference diodes in a series connection can in this case increase with increasing linear regulator stage. For example, the second linear regulator stage can have two (or more) reference diodes, the linear regulator stage 3 can have three (or more) reference diodes, etc.

In order to obtain current limiting, in each case one series resistance can be connected between two adjacent MOSFETs of the series connection. In addition, a series resistance can be connected between the MOSFET of the linear regulator stage 1 and the output. The current-limiting regulation is implemented by means of the feedback of the series resistance to the gate of the MOSFET.

In order to improve the scalability and the structure of the auxiliary voltage supply device further, the MOSFET and the at least one reference diode of same linear regulator stage can be combined to form a sub-assembly, that is to say a linear regulator module.

The invention also relates to a module for a modular multilevel converter. The module contains an intermediate circuit capacitor and switching assemblies, which are connected to one another in a half-bridge, full-bridge or another wiring arrangement, at least one set of control electronics for controlling the switching assemblies and at least one cascaded auxiliary voltage supply device as claimed in any one of the preceding claims. The cascaded auxiliary voltage supply device is connected to the intermediate circuit capacitor for supply with voltage and is configured to provide an auxiliary voltage for the control electronics. The invention also relates to a modular multilevel converter having at least one such module. The cascaded auxiliary voltage supply device of the previously mentioned module is preferably composed of a plurality of linear regulator modules.

For further explanation of the invention, reference is made, in the following part of the description, to figures from which further advantageous details and possible areas of application of the invention may be gleaned. The figures should be understood to be exemplary and are intended to illustrate the character of the invention, but in no way restrict it or even reproduce it definitively. The same reference signs are always used for elements having the same structure and/or the same function.

Other features which are considered as characteristic for the invention are set forth in the appended claims.

Although the invention is illustrated and described herein as embodied in a cascaded auxiliary voltage supply device for supplying voltage to control electronics of a module of a multilevel converter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic exemplary illustration of a module of a multilevel converter;

FIGS. 2-4 are circuit diagrams of advantageous embodiments of auxiliary voltage supply devices according to the invention;

FIG. 5 is a graph showing a comparison of an internal resistances of the auxiliary voltage supply device according to the invention having a conventional switched series resistor; and

FIG. 6 is a graph showing a comparison of a power loss of the auxiliary voltage supply device according to the invention having a conventional switched series resistor.

### DETAILED DESCRIPTION OF THE INVENTION

Referring now to the figures of the drawings in detail and first, particularly to FIG. 1 thereof, there is shown a module 1 for a modular multilevel converter 3. The modular multilevel converter 3 is only indicated dashed and generally has a plurality of similar modules 1. The module 1 may also be referred to as a submodule or a power module.

The module 1 has two module terminals 5 and 7, by means of which it can be connected in a series connection to further modules (not illustrated). The arrows 9 and 11 in FIG. 1 point to adjacent modules of this series connection.

The module 1 has two switching assemblies 13, which are preferably constructed identically and which are connected to the module terminals 5 and 7. In the module 1, which is illustrated by way of example, the switching assemblies 13 are connected to one another in a half-bridge circuit.

Alternatively, further switching assemblies 13 may also be present, in order to enable a full-bridge circuit for example. Furthermore, depending on the use case, other connection types are also possible.

Each switching assembly 13 has a power semiconductor switch 15 and a diode 17 that is connected antiparallel thereto. Each power semiconductor switch 15 is preferably formed by a bipolar transistor with insulated gate electrode (IGBT).

The module 1 furthermore has an intermediate circuit capacitor 19 as an energy store.

In order to bridge the submodule 1, particularly in a fault scenario, a bypass switch 21 is preferably connected between the two submodule terminals 5 and 7.

To control the switching assemblies 13, the module 1 comprises control electronics 23, which are indicated dashed in FIG. 1. In order to supply the control electronics 23 with voltage, an auxiliary voltage supply device 25 is provided, which in turn draws its voltage from the intermediate circuit capacitor 19.

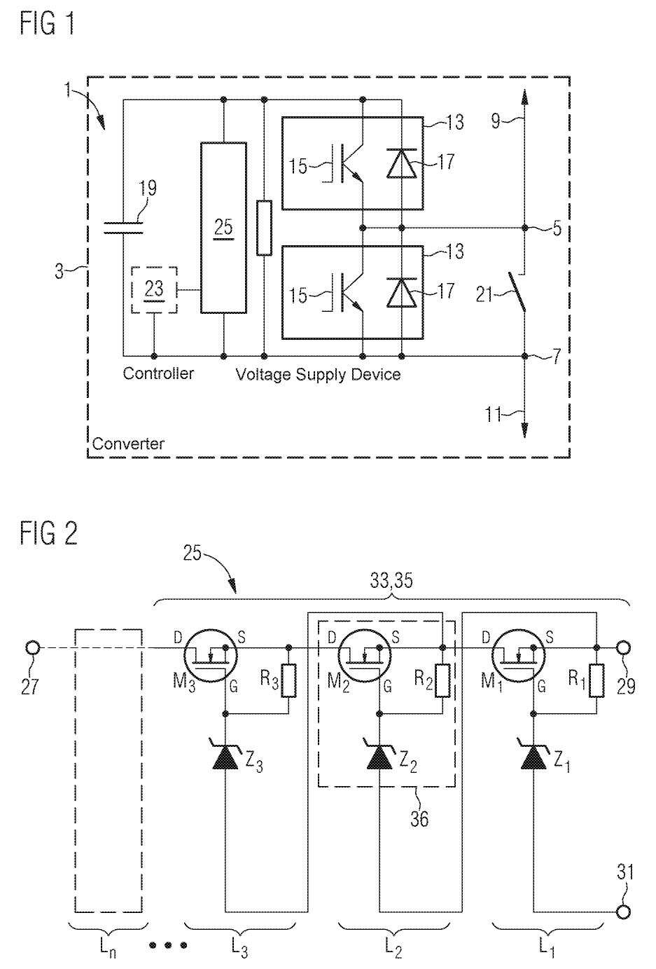

In the following, a first advantageous embodiment of a cascaded auxiliary voltage supply device 25 according to the invention is described with reference to FIG. 2. This can be used as an auxiliary voltage supply device 25 in the module 1 described with reference to FIG. 1.

The auxiliary voltage supply device 25 has an input 27, which can be connected to the intermediate circuit capacitor 19, an output 29 and a ground connection 31. Between the output 29 and the ground connection 31, the auxiliary voltage supplied by the auxiliary voltage supply device 25 can be tapped for the control electronics 23.

A cascade 33 of linear regulator stages L₁…Lₙis connected between the input 27 and the output 29. The order of the linear regulator stages L₁…Lₙruns from the input in the direction of the output. That is to say, linear regulator stage L₁ is closest to the output.

The linear regulator stage Lₙ positioned closest to the input is only indicated dashed in FIG. 2. The auxiliary voltage supply device 25 can be considered as a linear regulator 35 constructed from the cascade 33 of the linear regulator stages L₁…Lₙ.

Each linear regulator stage L₁…Lₙhas a normally on MOSFET (metal oxide semiconductor field effect transistor) M₁…Mₙ and at least one reference diode Z₁…Zₙ. The reference diode Z₁…Zₙ of a linear regulator stage L₁…Lₙ is connected to the gate electrode of the MOSFET M₁…Mₙ of same linear regulator stage L₁…Lₙ. The MOSFETs M₁…Mₙ of the linear regulator stages L₁…Lₙ are connected to one another in series.

The normally on MOSFETs M₁…Mₙ are conductive in a de-energized state and transition to a partially conductive state when voltage is applied. The electrodes of the MOSFETs M₁…Mₙ are labeled in FIG. 2 with the typical signs: G: gate electrode, D: drain electrode, and S: source electrode.

The reference diodes Z₁…Zₙ are preferably Zener diodes, the breakdown voltages of which define the setpoint voltages of the respective linear regulator stages L₁…Lₙ. To this end, the breakdown voltage of a reference diode Z₁…Zₙcontrols the gate-source voltage of the associated MOSFET M₁…Mₙ.

The output voltage of a linear regulator stage L₁…Lₙ is used in this case as a reference for the subsequent linear regulator stage L₁…Lₙ.

For each linear regulator stage L₁…Lₙ greater than 1, that is to say for the linear regulator stages L₂…Lₙ, the respective MOSFET M₂…Mₙ is connected via its source electrode S to the drain electrode D of the MOSFET M₁…Mₙ₋₁ of the next lowest stage.

In the illustrated embodiment, for each linear regulator stage L₁…Lₙ greater than 1, that is to say for the linear regulator stages L₂…Lₙ, exactly one reference diode Z₂…Zₙ is connected between the gate electrode G of the MOSFET M₂…Mₙ of this linear regulator stage and the source electrode S of the MOSFET M₁…Mₙ₋₁of the next lowest stage.

At least one of the MOSFETs M₁…Mₙ and the reference diode Z₁…Zₙof same linear regulator stage L₁…Lₙ can be combined to form a sub-assembly 36 (linear regulator module). This is indicated in FIG. 2 by way of example for the linear regulator stage L₂.

In the following, the mode of operation of the embodiment illustrated in FIG. 2 is briefly explained.

In the de-energized state, the series connection of the MOSFETs M₁…Mₙ is conductive. With increasing voltage, the difference between the input voltage and the desired output voltage falls at the MOSFETs M₁…Mₙ successively, starting with the MOSFET M₁ at the output 29 of the series connection, when these transition from conductive into only partially conductive operation (resistive character of the semiconductors). The voltage at the output 29 of the series connection is actively stabilized to an adjustable target value.

The voltage at the output 29 of the cascade 33 follows the input voltage until the setpoint voltage of the linear regulator stage L₁ is reached. The setpoint voltage of the linear regulator stage L₁ corresponds to the breakdown voltage (reference voltage) of the reference diode Z₁.

If the output voltage reaches the value of the breakdown voltage, a voltage drop across R₁, brought about by the current flow via the reference diode Z₁, is generated. The voltage drop across R₁ leads to a negative gate-source voltage and as a result controls the conductivity of the drain source channel of the MOSFET M₁.

For the linear regulator stage L₂, the voltage regulated by linear regulator stage L₁ is used as reference value. The reference diode Z₂ of the linear regulator stage L₂ is supported on the source potential of the MOSFET M₁. The linear regulator stage L₂ is completely conductive until the voltage applied at the source electrode S of the MOSFET M₂ is equal to the output voltage plus the breakdown voltage of the reference diode Z₂.

The realization of the self-supply in the form of a linear regulator 35 leads to an inherent regulation behavior (dynamic infinitely variable voltage regulation) of the output voltage. As a result, it is possible to dispense with the use of additional regulation components (forced regulation algorithms).

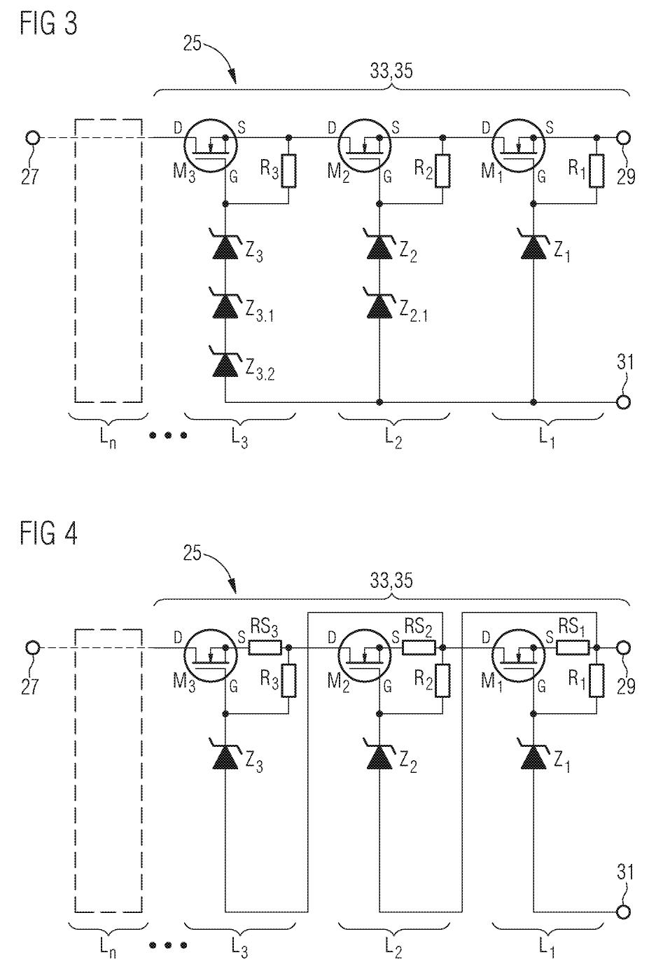

In the following, a further advantageous embodiment of the auxiliary voltage supply device 25 according to the invention is described with reference to FIG. 3. In this case, only the differences from the embodiment described with reference to FIG. 2 are discussed for the sake of brevity.

The second embodiment differs from the first embodiment due to the reference point of the reference diodes Z₁…Zₙ of the individual linear regulator stages L₁…Lₙ. While the reference diodes Z₁…Zₙ in the first embodiment always draw on the source potential of the preceding linear regulator stage L₁…Lₙ, in the second embodiment, the ground connection 31 is chosen as absolute reference point.

The consequence of this is that the number of reference diodes Z₁…Zₙ for each linear regulator stage L₁…Lₙ increases, in order to achieve the desired setpoint voltage. Thus, the first linear regulator stage L₁ has one reference diode Z₁. The linear regulator stage L₂ has the two reference diodes Z₂ and Z_{2.1}. The linear regulator stage L₃ has three reference diodes Z₃, Z_{3.1} and Z_{3.2}, etc.

The linear regulator stage L₂ is completely conductive until the voltage applied at the source electrode S of the MOSFET M₂ is equal to the sum of the breakdown voltages of the reference diodes Z₂and Z_{2.1}.

FIG. 4 shows a third advantageous embodiment of an auxiliary voltage supply device 25 according to the invention, which is described in the following. Here also, only the differences from the first embodiment described with reference to FIG. 2 are discussed for the sake of brevity.

The third embodiment of the auxiliary voltage supply device 25 is expanded, complementarily to the first embodiment, by in each case one series resistance RS₁…RSₙ for each linear regulator stage L₁…Lₙ. With the aid of these series resistances RS₁…RSₙ, the functionality of current limitation is realized.

The maximum flowing current corresponds to the quotient of gate-source threshold voltage of the respective MOSFET M₁…Mₙ and the value of the associated series resistance RS₁…RSₙ. In principle, it is therefore a voltage regulation with static current limitation.

FIG. 5 shows a comparison of the internal resistances of an auxiliary voltage supply device 25 according to the invention having a conventional switched series resistor.

In this case, the curve labeled with 37 shows the internal resistance of a conventional switched series resistor and the curve labeled with 39 shows the internal resistance of a cascaded auxiliary voltage supply device 25 according to the invention.

The output load in both variants is constantly 10 watts from an output voltage of 600 V. The cascaded auxiliary voltage supply device 25 has a linearly increasing internal resistance over the entire defined operating range.

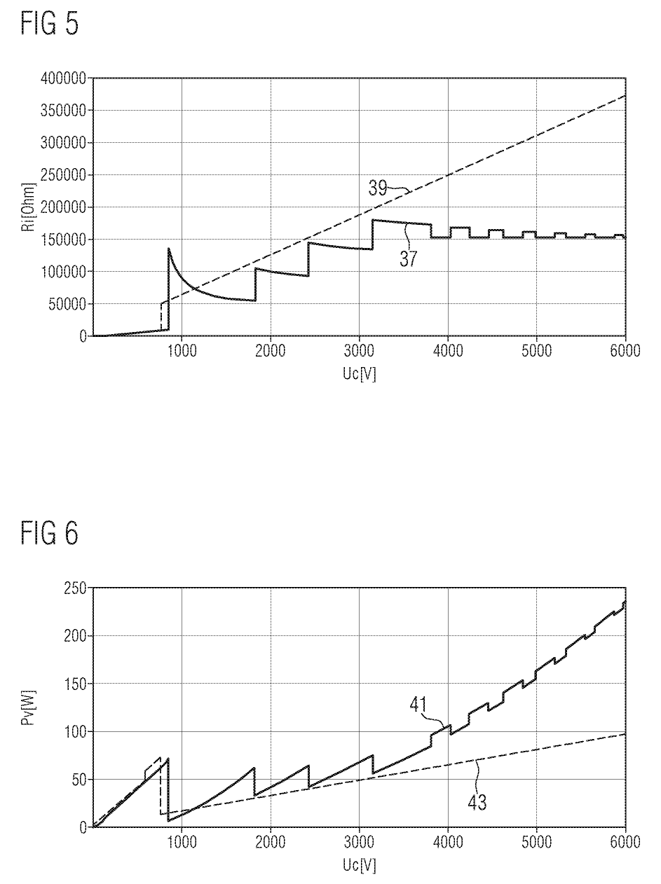

FIG. 6 shows a comparison of the power loss of an auxiliary voltage supply device 25 according to the invention having a conventional switched series resistor.

In this case, the curve labeled with 41 shows the power loss of a conventional switched series resistor and the curve labeled with 43 shows the power loss of a cascaded auxiliary voltage supply device 25 according to the invention.

The output load in both variants is constantly 10 watts from an output voltage of 600 V. The cascaded auxiliary voltage supply device 25 has a clearly better efficiency in the typical operating range and the operating voltage that is above that.

The following is a summary list of reference numerals and the corresponding structure used in the above description of the invention:
1 Module
3 Multilevel converter
5, 7 Module terminals
9, 11 Arrows
13 Switching assembly
15 Power semiconductor switch
17 Diode
19 Intermediate circuit capacitor
21 Bypass switch
23 Control electronics
25 Auxiliary voltage supply device
27 Input
29 Output
31 Ground connection
33 Cascade
35 Linear regulator
36 Sub-assembly
37 Internal resistance of a switched series resistor
39 Internal resistance of a cascaded auxiliary voltage supply device
41 Power loss of a switched series resistor
43 Power loss of a cascaded auxiliary voltage supply device
Z1…Zn Reference diodes
M1…Mn MOSFETs
R1…Rn Resistances
L1…Ln Linear regulator stages
RS1…RSn Series resistances
G Gate electrode
D Drain electrode
S Source electrode

1. An auxiliary voltage supply device for supplying voltage to control electronics of a module of a multilevel converter, the auxiliary voltage supply device comprising:
an intermediate circuit capacitor of the module is provided as a voltage source for the auxiliary voltage supply device;
a ground connection;
an output;
an input being connectable to said intermediate circuit capacitor, wherein an auxiliary voltage supplied by the auxiliary voltage supply device being tapped between said output and said ground connection; and
a cascade of linear regulator stages connected between said input and said output, wherein each of said linear regulator stages has a normally on metal oxide semiconductor field effect transistor with a gate electrode (MOSFET) and at least one reference diode which is connected to said gate electrode of said MOSFET, and wherein said MOSFETs of all of said linear regulator stages are connected to one another in series.

2. The auxiliary voltage supply device according to claim 1, wherein said reference diodes are Zener diodes, breakdown voltages of said Zener diodes define setpoint voltages of a respective one of said linear regulator stages.

3. The auxiliary voltage supply device according to claim 1, wherein an output voltage of a linear regulator stage of said linear regulator stages is used as a reference for a subsequent linear regulator stage of said linear regulator stages.

4. The auxiliary voltage supply device according to claim 1, wherein said MOSFET of a first linear regulator stage of said linear regulator stages has a source electrode connected to said output of the auxiliary voltage supply device and exactly one said at least one reference diode is connected between said gate electrode of said MOSFET and said ground connection of the auxiliary voltage supply device.

5. The auxiliary voltage supply device according to claim 4, wherein for each of said linear regulator stages greater than 1, said MOSFET is connected via said source electrode to a drain electrode of said MOSFET of a next lowest linear regulator stage of said linear regulator stages.

6. The auxiliary voltage supply device according to claim 5, wherein for each linear regulator stage of said linear regulator stages greater than 1, exactly one said at least one reference diode is connected between said gate electrode of said MOSFET of said linear regulator stage and said source electrode of said MOSFET of said next lowest linear regulator stage.

7. The auxiliary voltage supply device according to claim 5, wherein at each said linear regulator stage greater than 1, said at least one reference diode is one of a plurality of reference diodes connected in a series connection between said gate electrode of said MOSFET of said linear regulator stage and said ground connection.

8. The auxiliary voltage supply device according to claim 7, wherein a number of said reference diodes connected in series increases with an increasing linear regulator stage.

9. The auxiliary voltage supply device according to claim 1, further comprising one series resistance connected between two adjacent MOSFETs of a series connection for current limiting.

10. The auxiliary voltage supply device according to claim 1, wherein said MOSFET and said at least one reference diode of a same said linear regulator stage are combined to form a sub-assembly.

11. A module for a modular multilevel converter, the module comprising:
an intermediate circuit capacitor;
switching assemblies being connected to one another in a half-bridge, full-bridge or another wiring arrangement;
at least one set of control electronics for controlling said switching assemblies; and
said at least one auxiliary voltage supply device according to claim 1, wherein said at least one auxiliary voltage supply device is a cascaded auxiliary voltage supply device connected to said intermediate circuit capacitor for supplying a voltage and is configured to provide an auxiliary voltage for said at least one control electronics.

12. A modular multilevel converter, comprising:
said at least one module according to claim 11.
